(19) United States
(12) Patent Application Publication
(10) Pub. No.: US 2015/0128615 A1
(43) Pub. Date: May 14, 2015

(54) COLD BEVERAGE DISPENSER IMPLEMENTING THERMOELECTRIC COOLING

(71) Applicants: Ruguo Hu, Shanghai (CN); Ting Deng, Shanghai (CN)

(72) Inventors: Ruguo Hu, Shanghai (CN); Ting Deng, Shanghai (CN)

(73) Assignee: NESTEC S.A., Vevey (CH)

(21) Appl. No.: 14/402,491

(22) PCT Filed: May 25, 2012
(86) PCT No.: PCT/CN2012/076067

§ 371 Date: Dec. 1, 2014

(51) Int. Cl. F25B 21/02; B67D 7/80

(52) U.S. Cl. CPC F25B 21/02; B67D 7/80; F25B 2321/02
USPC 62/3.64

(57) ABSTRACT

The invention concerns a chilled beverage dispenser comprising:—a beverage cooling reservoir (1) comprising a thermo-electric device (2) and a temperature sensor (10),—a beverage supply (3),—a pump (4) for pumping the beverage from the beverage supply to the beverage cooling reservoir,—a line (5) for dispensing chilled beverage from 51 the outlet (9) of the beverage cooling reservoir, said line comprising a dispense valve (51), wherein the dispenser comprises a beverage recirculation line (6) for recirculating the beverage from the beverage cooling reservoir outlet (9) through the pump (4) back to the beverage cooling reservoir.

### FIELD OF THE INVENTION

The present invention relates to beverage dispensers configured for providing cold beverages.

### BACKGROUND OF THE INVENTION

Beverage dispensers providing cold beverages can cool beverages or diluents from ambient temperature to cold temperatures by establishing a heat exchange between the beverage or the diluent with a cold source. Current common used cold sources comprise refrigerator using refrigerant gas compression principle and thermoelectric cooling. Thermoelectric cooling has the advantages of presenting a small module size, of creating lower working noise and cost and of being environmental friendly. However thermoelectric cooling presents lower cooling efficiency and capacity.

The present invention refers to thermoelectric cooling implemented in a cold beverage dispenser comprising a beverage cooling reservoir in which beverage is introduced. A part of the beverage cooling reservoir is in contact with a thermoelectric cooling assembly heat transfer can be established between the beverage present in the reservoir and the thermoelectric cooling assembly.

In such a cold beverage dispense, when no beverage is drawn for consumption, the beverage in the reservoir remains static, which can lead to an important gradient of temperature inside the reservoir, the colder temperature being reached near to the thermoelectric cooling assembly.

This unequal temperature in the reservoir affects the time for cooling down the beverage and the period for recovering after consumption, because the thermoelectric cooling assembly only acts when the detected temperature is higher than the required temperature. If a layer of thick ice forms on or near the thermoelectric cooling assembly contact area it may not reflect the effective temperature in the rest of the reservoir. In order to maximize the cooling efficiency of TEC module and shorten the cooling down period, modification on waterway to enhance heat transfer and in-tank temperature homogenization is inquired herein.

Another issue with the presence of ice on the reservoir part near to the thermoelectric cooling assembly is that the volume of ice reduces the volume of reservoir for admitting and cooling liquid beverage and less cold beverage can be drawn from the reservoir. Even if an ice bank is present in the cooling reservoir, it would hardly immediately unfreeze to meet the requirements of multi-cups consumption. Otherwise, temperature in cup will be higher than expectation due to the filling up of liquid at ambient.

Additionally, the whole cooling reservoir system might freeze up in case the thermoelectric cooling assembly has non-stop worked for days without any consumption, especially when the temperature sensor setting is out of tolerance or out of control. In this case, leakage of waterway will be resulted in at the end, such as failed sealing for cooling reservoir or even the broken piping & connectors because of the expanding ice. Thus, the volume of ice should be under control.

RU 2367857 describes an automated beverage tapping machine comprising a batch volume tank in contact with a thermoelectric element for water cooling within 0 to 4° C. The water cooling process is based on power adjustment of the thermoelectric element and water mixing due to the density difference of water layers generated when power rises at the thermoelectric element. This mixing effect is yet rather theoretical and slow and there is a big risk that the tank might totally freeze. Finally such a taping machine would not be efficient for supporting multi-cups consumption.

EP 777 090 describes a beer supply apparatus comprising a tank with a Peltier cooling device in which the ice making amount is efficiently controlled. The beer circulates in a coiled beverage duct immersed in the tank. The tank comprises a mechanical agitator that uses additional energy. The apparatus also comprises a complex sensor and control system implementing at least two sensors for detecting ice forming and for measuring temperature in the tank. The controller adjusts several parameters like power supply, Peltier cooling device working power, fan speed, mechanical agitator, . . . Consequently the apparatus is complex and expensive in production. Besides this apparatus is not concerned by the problem of tank volume reduction due to the formation of ice since the water in the tank is not dispensed.

The object of the present invention is to propose a cold beverage dispenser comprising a beverage cooling reservoir and a thermoelectric assembly for cooling the reservoir in which a good temperature homogenization of the beverage can be reached for avoiding ice increase.

Another object of the present invention is to propose a cold beverage dispenser comprising a beverage cooling reservoir and a thermoelectric assembly for cooling the reservoir with enhanced heat conduction that does not implement a mechanical stirrer.

### SUMMARY OF THE INVENTION

According to a first aspect, the invention concerns a chilled beverage dispenser comprising:

a beverage cooling reservoir comprising a thermo-electric device and a temperature sensor,

a beverage supply,

a pump for pumping the beverage from the beverage supply to the beverage cooling reservoir,

a line for dispensing chilled beverage from the outlet of the beverage cooling reservoir, said line comprising a dispense valve,

wherein the dispenser comprises a beverage recirculation line for recirculating the beverage from the beverage cooling reservoir outlet through the pump back to the beverage cooling reservoir.

According to the preferred embodiment the dispenser comprises:

a selector valve connecting either the beverage supply or the beverage recirculation line to the pump,

a three-way connector connecting the outlet of beverage cooling reservoir to the dispensing line and to the recirculation loop.

The dispenser usually comprises a temperature sensor in the beverage cooling reservoir. Preferably the temperature sensor is placed far from the side of the beverage cooling reservoir comprising the thermo-electric device.

According to the preferred embodiment of the dispenser the inlet for introducing the pumped beverage in the beverage cooling reservoir comprises a nozzle configured for agitating the beverage in the container. The nozzle is preferably configured so as to direct the pumped beverage to the side of the beverage cooling reservoir comprising the thermo-electric device.

The dispenser of the present invention can comprise a beverage diverted line for delivering ambient beverage, said line comprising a dispense valve and said line being connected:

either between the pump and the recirculation line,

or between the pump and the beverage cooling reservoir.

Usually the beverage diverted line is connected through a three-way connector.

The beverage dispenser according to the present invention generally comprises a controller configured for controlling the recirculation of the beverage in the beverage recirculation line depending at least in part on the monitoring of the temperature sensor. When the beverage dispenser comprises a selector valve connecting either the beverage supply or the beverage recirculation loop to the pump, the controller can control the position of said selector valve.

According to a second aspect the invention concerns a process for dispensing a beverage at a target temperature T₀ with a chilled beverage dispenser such as described hereabove wherein, if based on the measure of temperature sensor in the beverage cooling reservoir the difference ΔT between the target temperature T₀ and the temperature T in the beverage cooling reservoir is greater than a predetermined value, for example 0.5° C., then the beverage is recirculated through the beverage recirculation loop.

According to the preferred embodiment the beverage is discontinuously recirculated through the beverage recirculation loop. By discontinuously it is meant that the pump can be activated by impulses so as to maintain a global recirculation but without consuming too much energy for the activation of the pump. The type and rate of the recirculation like the pump working duration and intervals between pump impulses can be adapted according to the features of the dispenser (reservoir volume, type of pump, . . . ).

Preferably, if based on the measure of temperature sensor in the beverage cooling reservoir the difference ΔT between the target temperature T₀ and the temperature T in the beverage cooling reservoir is less than a predetermined value, for example 0.5° C., then the beverage is not recirculated through the beverage recirculation loop.

It is also preferred that, if based on the measure of temperature sensor in the beverage cooling reservoir the difference ΔT between the target temperature T₀ and the temperature T in the beverage cooling reservoir is less than 0.5° C., then the thermo-electric device is put on stand-by.

In the present invention the term “beverage” represents either a beverage that can be readily drunk like a prepared beverage (often called ready-to-drink) or water or a diluent (like water) that can subsequently used to prepare a beverage by dilution, brewing, extraction, mixing with a beverage ingredient like soluble beverage powders (instant coffee, milk powder, cocoa powder, . . . ), liquid concentrates (coffee concentrate, milk concentrate, . . . ) or roast and ground coffee, tea leaves, herbs, botanicals, as well as other substances.

### BRIEF DESCRIPTION OF THE DRAWINGS

The characteristics and advantages of the invention will be better understood in relation to the following figures.

FIG. 1 is a schematic diagram of the fluid system of a chilled beverage dispenser according to the present invention.

FIG. 2 is a schematic diagram of the fluid system of an alternative chilled beverage dispenser according to the present invention.

FIGS. 3a and 3b respectively illustrate a front and a side view of a nozzle that can be used in the reservoir of the dispenser according to the invention.

FIG. 3c illustrates the jets created by the nozzle of FIGS. 3a, 3c in the reservoir.

### DETAILED DESCRIPTION OF THE DRAWINGS

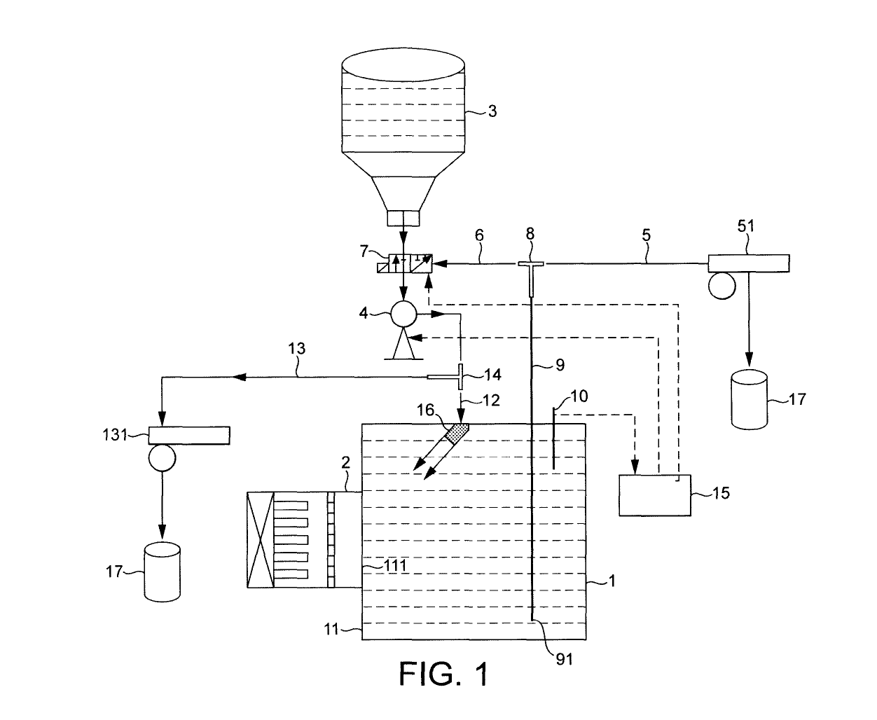

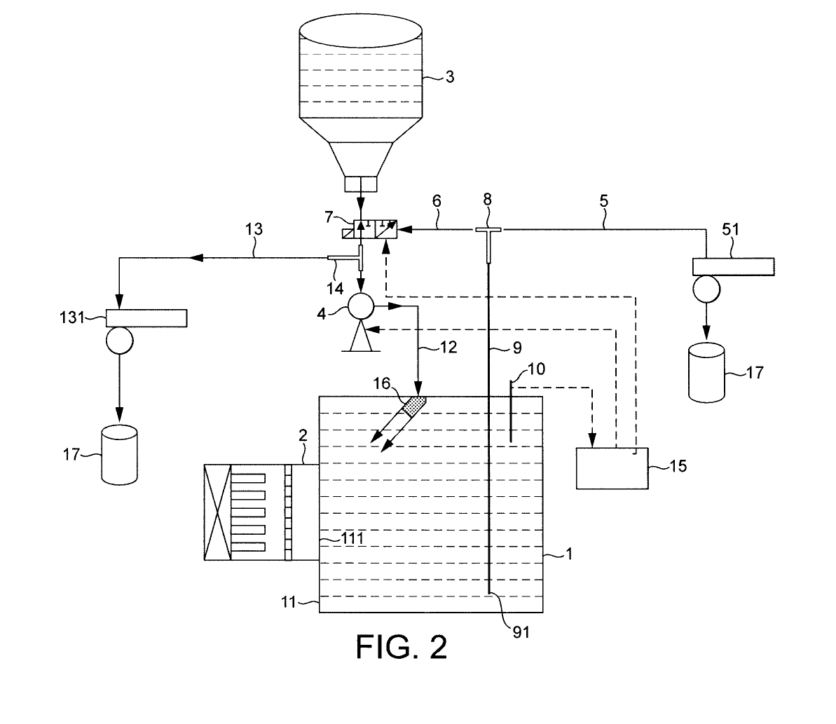

FIGS. 1 and 2 illustrate two variants of the fluid system of a cold beverage dispenser according to the present invention. The dispenser comprises a beverage cooling reservoir 1 for receiving the beverage that is introduced through an inlet 12. The reservoir 1 is equipped with a thermo-electric device 2 for cooling (also called Peltier cooling device). The thermo-electric device 2 is affixed to a side of the reservoir so as to transfer heat from the beverage stored in the reservoir to the thermo-electric device. The reservoir 1 comprises a temperature sensor 10 to control the temperature of the beverage. The sensor 10 is preferably positioned so as to measure the temperature far—preferably far above—from the side 11 of the reservoir in contact with the thermoelectric device. Any type of temperature sensor can be used for example a negative temperature coefficient thermistor (NTC).

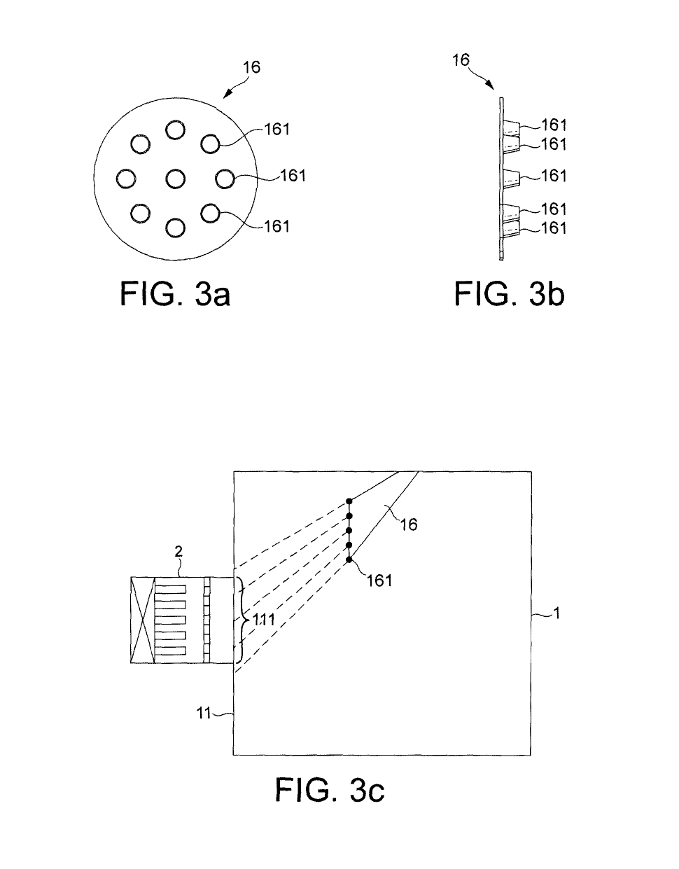

The dispenser comprises a beverage supply 3. This supply can indifferently be a bottle of beverage or a bigger reservoir or even a liquid line like tap water. The dispenser comprises a pump 4 for pumping the beverage from the beverage supply 3 to the beverage cooling reservoir 1 through the inlet 12. According to the preferred embodiment the inlet 12 for introducing the pumped beverage comprises a nozzle 16 configured for agitating the beverage or creating turbulence in the reservoir when the pumped beverage is introduced in the reservoir. Most preferably this nozzle 16 is configured so as to direct the pumped beverage flow from the inlet tube to the side 11 of the reservoir comprising the thermo-electric device and preferably to the coldest part of said side 11 that is the part 111 in contact with the thermoelectric device 2. Due to this position and orientation of the inlet nozzle, pumped beverage is jetted to the coldest part of the reservoir and more heat can be transferred to said cold part. It has been observed that a nozzle configured for dispensing the pumped beverage in the form of a diverging jet provides the best performance. For example FIGS. 3a, 3b respectively illustrate a front and a side view of a nozzle 16 that can be used according to the invention. The nozzle is an assembly of several sub-nozzles 161 that are circularly positioned in order to create a shower effect such as illustrated in FIG. 3c. Preferably the beverage shower jets should cover at least the coldest surface of the reservoir which is generally the surface 111 of the reservoir to which is affixed the thermo-electric device 2. It has also been observed that no or few ice forms on the reservoir side near from the thermo-electric device.

The beverage flows out of the reservoir 1 through an outlet 9 that is preferably a plunger tube of which inlet 91 is positioned near from the bottom of the reservoir. Such design of 91 closed to the bottom of reservoir can ensure that beverage at the chilled temperature is first ‘pushed’ out into cup and that the beverage is dispensed at the requested chilled temperature. Actually when a cold beverage is dispensed through the dispense valve 51, the pump 4 is simultaneously activated and beverage is simultaneously pumped from the beverage supply 3 and introduced in the reservoir 1 through the inlet 12. This pumped beverage which is at ambient temperature does not mix with the cold beverage directly pumped through the outlet 9.

The dispenser comprises a line 5 for dispensing the cold beverage from the outlet 9 of the reservoir. At its end this dispensing line 5 comprises a dispense valve 51 that is activated on demand for delivering the beverage in a drinking cup 17.

According to the invention the dispenser comprises a beverage recirculation line 6 for recirculating the beverage from the beverage cooling reservoir outlet 9 through the selector valve 7 and the pump 4 back to the reservoir 1. This line is connected to the reservoir outlet 9 and to the dispensing line 5 by a three-way connector 8 like a T-tube. The other side of the recirculation line 6 is connected to the pump 4. The connection is made though a selector valve 7 that is able to connect either the recirculation line 6 or the beverage supply 1 to the pump 4. The selector valve 7 can be a solenoid three-way valve. Consequently depending if the dispense valve 51 in the dispensing line 5 is closed or opened, cold beverage from the reservoir 1 can circulate through the dispensing line 5 or recirculate to the pump 4. When the dispense valve 51 is opened, the selector valve 7 is positioned so as to close the recirculation line 6 and the pump 4 is activated to deliver the cold beverage from the reservoir 1 to the dispense valve 51 through the dispensing line 5 ; simultaneously beverage at ambient temperature is pumped from the supply 3 and introduced in the reservoir 1. When the dispense valve 51 is closed and the recirculation is activated, the selector valve 7 is positioned so as to close the supply of water 3 to the reservoir 1 and so as to connect the recirculation line 6 with the inlet 12 and the pump 4 is activated.

Optionally the dispenser can comprise a beverage diverted line 13 for dispensing ambient beverage. This line can comprise a dispense valve 131 that can be activated on demand. The beverage diverted line 13 can be connected:

either between the pump 4 and the reservoir 1 as illustrated in FIG. 1,

or between the pump 4 and the recirculation line 6 as illustrated in FIG. 2.

In both cases the beverage diverted line 13 is connected through a three-way connector 14 like a T tube.

Finally the beverage dispenser comprises a controller 15 that receives information from the temperature sensor 10 about the temperature of the beverage far above the thermo-electric device 11. The temperature sensor 10 is also preferably far from the reservoir inlet 12. Depending on the value of said temperature the controller is configured for simultaneously activating the selector valve 7 and the pump 4 for recirculating the beverage through the recirculation line 6. If the selector valve 7 is activated to establish communication between the recirculation line 6 and the reservoir inlet 12 and the pump 4 is activated, recirculation is implemented.

The controller is usually set so that the dispenser delivers cold beverage at a targeted temperature T₀. The controller controls the value of the temperature measured by the temperature sensor 10 in the beverage cooling reservoir 1 and calculates the difference ΔT between the target temperature T₀ and the temperature T in the beverage cooling reservoir 1. If this difference is greater than e.g. 0.5° C., then the recirculation through the recirculation line 6 has to be operated so as to improve the cooling of the beverage which means that the selector valve 7 is operated so as to connect the circulation line 6 with the pump 4 and the pump 4 is activated. The recirculation of the beverage is implemented until the controller 15 controls that the difference ΔT becomes less than 0.5° C. The recirculation of the beverage can be implemented either in a continuous manner or in a discontinuous manner. In general during the discontinuous recirculation, pump 4 is temporally put on stand-by from time to time or works by impulses. The hereabove value of 0.5° C. for the difference ΔT can be adjusted depending on the temperature sensor precision and the accuracy of the temperature control requirement.

During process control by the controller if ΔT is less than 0.5° C., then the beverage is not recirculated through the beverage recirculation loop 6 and preferably the thermo-electric device 2 is put on stand-by.

Usually after a beverage dispensing operation through the dispensing line 5, the beverage recirculation through the beverage recirculation loop 6 is implemented in order to rapidly cool the beverage that has been simultaneously introduced from the supply 3 in the reservoir 1.

Although not illustrated the present dispenser can also comprise a hot beverage dispensing line in parallel to the hereabove described cold beverage line.

The dispenser of the present invention presents the advantage of enabling short cooling time and recovery time after consumption which results in less power consumption of the thermo-electric device. For example a dispenser comprising a water cooling reservoir with an internal volume of 1 litre and a thermoelectric chip of 90 W and placed in an environment temperature of 22° C. cooled water in the reservoir at 10° C. in 30 minutes by implementing the recirculation of water according to the present invention. The same dispenser that did not implement a recirculation of water according to the present invention needed 40 minutes to reach the same temperature.

Another advantage of the present invention is that less ice forms on the coldest side of the reservoir which supports multi-cups consumption and which avoids risk of leakage due to uncontrolled ice growth.

Another advantage of the present invention is that the same pump can be used for drawing the beverage and for recirculating the beverage, no additional device like an agitator has to be implemented.

1. A chilled beverage dispenser comprising:
a beverage cooling reservoir comprising a thermo-electric device and a temperature sensor;
a beverage supply;
a pump for pumping the beverage from the beverage supply to the beverage cooling reservoir;
a line for dispensing chilled beverage from the outlet of the beverage cooling reservoir, the line comprising a dispense valve; and
the dispenser comprises a beverage recirculation line for recirculating the beverage from the beverage cooling reservoir outlet through the pump back to the beverage cooling reservoir.

2. A chilled beverage dispenser according to claim 1, comprising:
a selector valve connecting either the beverage supply or the beverage recirculation loop to the pump; and
a three-way connector connecting the outlet of beverage cooling reservoir to the dispensing line and to the recirculation line.

3. A chilled beverage dispenser according to claim 1, wherein the temperature sensor is placed far from the side of the beverage cooling reservoir comprising the thermo-electric device.

4. A chilled beverage dispenser according to claim 1, wherein the inlet for introducing the pumped beverage in the beverage cooling reservoir comprises a nozzle configured for agitating the beverage in the reservoir.

5. A chilled beverage dispenser according to claim 1, wherein the nozzle is configured so as to direct the pumped beverage flow to the side of the beverage cooling reservoir comprising the thermo-electric device.

6. A chilled beverage dispenser according to claim 1, comprising a beverage diverted line for delivering ambient beverage, the line comprising a dispense valve and the line being connected:
either between the pump and the recirculation line,
or between the pump and the beverage cooling reservoir.

7. A chilled beverage dispenser according to claim 1, wherein the beverage diverted line is connected through a three-way connector.

8. A chilled beverage dispenser according to claim 1, comprising a controller configured for controlling the recirculation of the beverage in the beverage recirculation line depending at least in part on the monitoring of the temperature sensor.

9. A chilled beverage dispenser according to claim 1, comprising a selector valve connecting either the beverage supply or the beverage recirculation loop to the pump and the controller controls the position of the selector valve.

10. A process for dispensing a beverage at a target temperature T₀ with a chilled beverage dispenser wherein if, based on the measure of a temperature sensor in the beverage cooling reservoir, the difference between the target temperature T₀ and the temperature T in the beverage cooling reservoir is greater than 1° C., then the beverage is recirculated through the beverage recirculation loop.

11. A process according to claim 10, wherein the beverage is discontinuously recirculated through the beverage recirculation loop.

12. A process according to claim 10, wherein, if based on the measure of temperature sensor in the beverage cooling reservoir, the difference between the target temperature T₀ and the temperature T in the beverage cooling reservoir is less than 1° C., then the beverage is not recirculated through the beverage recirculation loop.

13. A process according to claim 1 wherein, if based on the measure of temperature sensor in the beverage cooling reservoir the difference between the target temperature T₀ and the temperature T in the beverage cooling reservoir is less than 1° C., then the a thermo-electric device in the beverage dispenser is put on standby.

14. A process according to claim 10 wherein after a beverage dispensing operation through the dispensing line, the beverage is recirculated through the beverage recirculation loop.
